(19) United States
(12) Patent Application Publication
(10) Pub. No.: US 2024/0343480 A1
(43) Pub. Date: Oct. 17, 2024

(54) ATTACHMENT SYSTEM FOR VEHICLE

(71) Applicant: Oshkosh Corporation, Oshkosh, WI (US)

(72) Inventors: Jason Rice, Oshkosh, WI (US); Jeremy Bernard, Oshkosh, WI (US)

(73) Assignee: Oshkosh Corporation, Oshkosh, WI (US)

(21) Appl. No.: 18/634,203

(22) Filed: Apr. 12, 2024

Related U.S. Application Data
(60) Provisional application No. 63/459,381, filed on Apr. 14, 2023.

(51) Int. Cl. B65F 3/04; B65F 3/02

(52) U.S. Cl. CPC B65F 3/041; B65F 2003/0279

(57) ABSTRACT

An intermediate carry can for a refuse vehicle includes a container configured to couple to the refuse vehicle, an extension arm coupled to the container, and an attachment member coupled to an end of the extension arm. The attachment member has an interface configured to engage with a plurality of attachments to facilitate selectively interchanging the plurality of attachments. The interface defines a first plurality of apertures and a second plurality of apertures that facilitate adjusting a position of at least one of the plurality of attachments relative to the attachment member.

### CROSS-REFERENCE TO RELATED PATENT APPLICATION

This application claims the benefit of and priority to U.S. Provisional Patent Application No. 63/459,381, filed Apr. 14, 2023, which is incorporated herein by reference in its entirety.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One embodiment relates to an intermediate carry can for a refuse vehicle. The intermediate carry can includes a container configured to couple to the refuse vehicle, an extension arm coupled to the container, and an attachment member coupled to an end of the extension arm. The attachment member has an interface configured to engage with a plurality of attachments to facilitate selectively interchanging the plurality of attachments. The interface defines a first plurality of apertures and a second plurality of apertures that facilitate adjusting a position of at least one of the plurality of attachments relative to the attachment member.

In some embodiments, the first plurality of apertures and the second plurality of apertures are spaced vertically along at least a portion of a height of the attachment member. In some embodiments, the first plurality of apertures and the second plurality of apertures are configured as first slots orientated at a first angle. In some embodiments, the first plurality of apertures and the second plurality of apertures facilitate adjusting the position of the at least one of the plurality of attachments horizontally along the attachment member and vertically along the attachment member.

In some embodiments, the attachment member further has a first edge and an opposing second edge. In some embodiments, the first plurality of apertures are positioned proximate the first edge and the second plurality of apertures are positioned proximate the opposing second edge.

In some embodiments, an outermost end of the first plurality of apertures proximate the first edge is positioned higher than an innermost end of the first plurality of apertures. In some embodiments, an outermost end of the second plurality of apertures proximate the opposing second edge is positioned higher than an innermost end of the second plurality of apertures.

In some embodiments, the attachment member includes a pair of bends positioned at the first edge and the opposing second edge and extending from the attachment member towards the container. In some embodiments, the intermediate carry can also includes a plurality of fasteners extending through one of the first plurality of apertures of the second plurality of apertures configured to engage the attachment member with the plurality of attachments. In some embodiments, the plurality of fasteners are configured to selectively limit adjusting the position of the at least one of the plurality of attachments relative to the attachment member.

In some embodiments, the plurality of fasteners are configured to selectively apply a clamp load on the attachment member and the at least one of the plurality of attachments to selectively limit adjusting the position of the at least one of the plurality of attachments relative to the attachment member. In some embodiments, each of the plurality of fasteners include a bolt extending through (i) one of the first plurality of apertures or the second plurality of apertures of the interface of the attachment member and (ii) the at least one of the plurality of attachments. In some embodiments, each of the plurality of fasteners include a nut threaded onto the bolt and tightened against the attachment member or the at least one of the plurality of attachments to selectively apply the clamp load on the attachment member and the at least one of the plurality of attachments.

In some embodiments, the plurality of attachments include a first attachment comprising a first manipulator configured to engage a first type of a refuse container. In some embodiments, the plurality of attachments include a second attachment comprising a second manipulator configured to engage a second type of refuse container.

Another embodiment relates to an intermediate carry can for a refuse vehicle. The intermediate carry can includes a container configured to couple to the refuse vehicle, an extension arm coupled to the container, and an attachment member coupled to an end of the extension arm. The extension arm is configured to extend laterally in a direction transverse to a direction of travel of the refuse vehicle. The attachment member has an interface configured to engage with a plurality of attachments to facilitate selectively interchanging the plurality of attachments. The plurality of attachments include a first manipulator configured to engage a first type of refuse container and a second manipulator configured to engage a second type of refuse container.

Still another embodiment relates to a refuse vehicle. The refuse vehicle includes a chassis, a body assembly coupled to the chassis, a lift assembly, an attachment assembly coupled to the lift assembly, and an accessory selectively secured to the lift assembly by the attachment assembly. The body assembly defines a vehicle refuse compartment. The accessory includes an extension arm extension arm configured to extend laterally in a direction transverse to a direction of travel of the refuse vehicle and an attachment member coupled to an end of the extension arm. The attachment arm has an interface configured to engage with a plurality of attachments to facilitate selectively interchanging the plurality of attachments. The interface defines a first plurality of apertures and a second plurality of apertures that facilitate adjusting a position of at least one of the plurality of attachments relative to the attachment member.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a refuse vehicle, according to an exemplary embodiment;

FIG. 2 is a perspective view of a container attachment for the refuse vehicle of FIG. 1 having an extension arm in a retracted position, according to an exemplary embodiment;

FIG. 3 is a perspective view of the container attachment of FIG. 2 having the extension arm in an extended position, according to an exemplary embodiment;

FIG. 4 is a detailed perspective view of the extension arm of FIG. 3 in the extended position, according to an exemplary embodiment;

FIG. 5 is a detailed perspective view of an attachment interface coupled to a distal end of the extension arm of FIG. 4, according to an exemplary embodiment;

FIG. 6 is a front view of the attachment interface of FIG. 5, according to an exemplary embodiment;

FIG. 7 is a perspective view of a first attachment coupled to the attachment interface of FIG. 5, according to an exemplary embodiment;

FIG. 8 is a detailed perspective view of the first attachment coupled to the attachment interface shown in FIG. 7 according to an exemplary embodiment;

FIG. 9A is a detailed front view of the first attachment coupled to the attachment interface shown in FIG. 8, according to an exemplary embodiment;

FIG. 9B is an adjusted view of the detailed front view shown in FIG. 9A showing a vertical positional adjustment of the first attachment relative to the attachment interface, according to an exemplary embodiment;

FIG. 9C is an adjusted view of the detailed front view shown in FIG. 9A showing a horizontal positional adjustment of the first attachment relative to the attachment interface, according to an exemplary embodiment;

FIG. 9D is an adjusted view of the detailed front view shown in FIG. 9A showing a vertical positional adjustment and a horizontal positional adjustment of the first attachment relative to the attachment interface, according to an exemplary embodiment;

FIG. 10 is a perspective view of a second attachment that is couplable to the attachment interface of FIG. 5, according to an exemplary embodiment; and

FIG. 11 is a block diagram of the plate of FIG. 6 and a plurality of attachments, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, an intermediate carry can for a refuse vehicle (e.g., a front-loading refuse vehicle) includes an extendable arm having an attachment system coupled a distal end of the extendable arm. The attachment system is configured to facilitate selectively and releasably coupling a plurality of different attachments (e.g., a tipping device or tipper, a grabber device or grabber mechanism, etc.) to the extendable arm. Such an attachment system may advantageously allow an operator to use the refuse vehicle for various applications and/or switch attachments usable with the intermediate carry can with relative ease. Additionally, such an attachment system may enable quick swapping of different refuse vehicle device attachments using existing hardware for the grabber, tipper, and/or other devices, and enable rapid alignment and adjustment of the attachments relative to the intermediate carry can to conform with the unique requirements associated with the refuse vehicle application. By enabling an operator to quick-swap different refuse vehicle device attachments and rapidly align and adjust the attachments, the attachment system may streamline the servicing required to change a configuration of the refuse vehicle, reducing down time and increasing an amount of time that the refuse vehicle may be in service.

By way of example, a grabber device may be attached to the extendable arm such that the refuse vehicle may be used for refuse collection to collect refuse from a first type of refuse container (e.g., by the grabber device engaging the first type of refuse container, etc.), such as by grasping and tipping the first type of refuse container into a refuse compartment defined by the intermediate carry can (e.g., using separate actuations, etc.). By way of another example, a tipping device may be attached to the extendable arm such that the refuse vehicle may be used to collect refuse from a second type of refuse container (e.g., a container that includes an interface that engages with the tipping device, by the tipping device engaging the second type of refuse container, etc.) by interlocking with and tipping the second type of refuse container (e.g., using a single actuation, etc.) into the refuse compartment defined by the intermediate carry can. Additionally, the attachment system may advantageously allow an operator to adjust the position of the attachments during installation of the attachments to the attachment system of the extendable arm. In some embodiments, the attachment system is positioned at a different location along the refuse vehicle, including for implementations that do not include an intermediate can (e.g., on the refuse vehicle body, on a side-loading arm of the refuse vehicle, at a tailgate of the refuse vehicle, etc.).

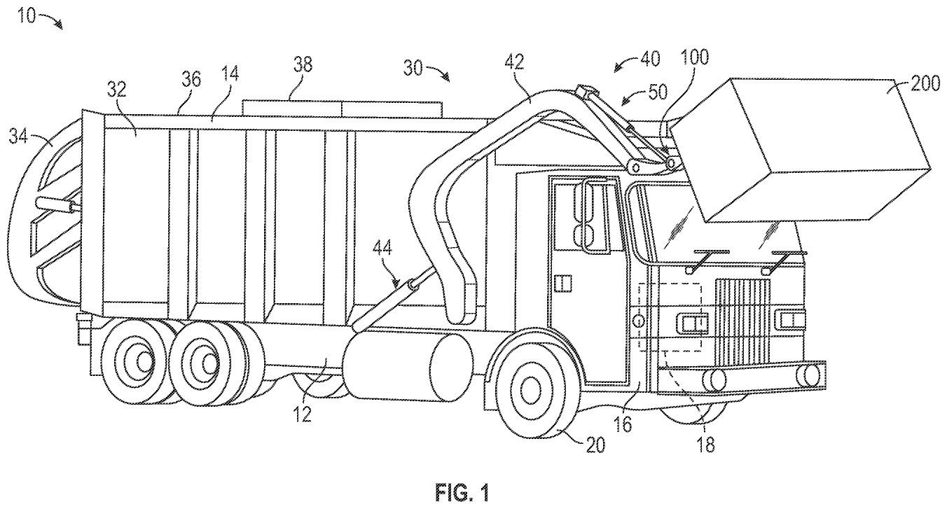

As shown in FIG. 1, a vehicle, shown as refuse vehicle 10 (e.g., a garbage truck, a waste collection truck, a sanitation truck, a recycling truck, etc.), is configured as a front-loading refuse truck. In other embodiments, the refuse vehicle 10 is configured as a side-loading refuse truck or a rear-loading refuse truck. In still other embodiments, the vehicle is another type of vehicle (e.g., a skid-loader, a telehandler, a plow truck, a boom lift, etc.). As shown in FIG. 1, the refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, actuator controls, a user interface, switches, buttons, dials, etc.).

As shown in FIG. 1, the refuse vehicle 10 includes a prime mover, shown as engine 18, coupled to the frame 12 at a position beneath the cab 16. The engine 18 is configured to provide power to a plurality of tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, biodiesel, ethanol, natural gas, etc.), according to various exemplary embodiments. According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from an on-board storage device (e.g., batteries, ultra-capacitors, etc.), from an on-board generator (e.g., an internal combustion engine, etc.), and/or from an external power source (e.g., overhead power lines, etc.) and provide power to the systems of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (i.e., refuse is loaded into a position of the refuse compartment 30 behind the cab 16 and stored in a position further toward the rear of the refuse compartment. In other embodiments, the storage volume is positioned between the hopper volume and the cab 16 (e.g., a rear-loading refuse vehicle, etc.).

As shown in FIG. 1, the refuse vehicle 10 includes a lift mechanism/system (e.g., a front-loading lift assembly, etc.), shown as lift assembly 40. The lift assembly 40 includes a pair of arms, shown as lift arms 42, coupled to the frame 12 and/or the body 14 on either side of the refuse vehicle 10 such that the lift arms 42 extend forward of the cab 16 (e.g., a front-loading refuse vehicle, etc.). In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). The lift arms 42 may be rotatably coupled to frame 12 with a pivot (e.g., a lug, a shaft, etc.). As shown in FIG. 1, the lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment.

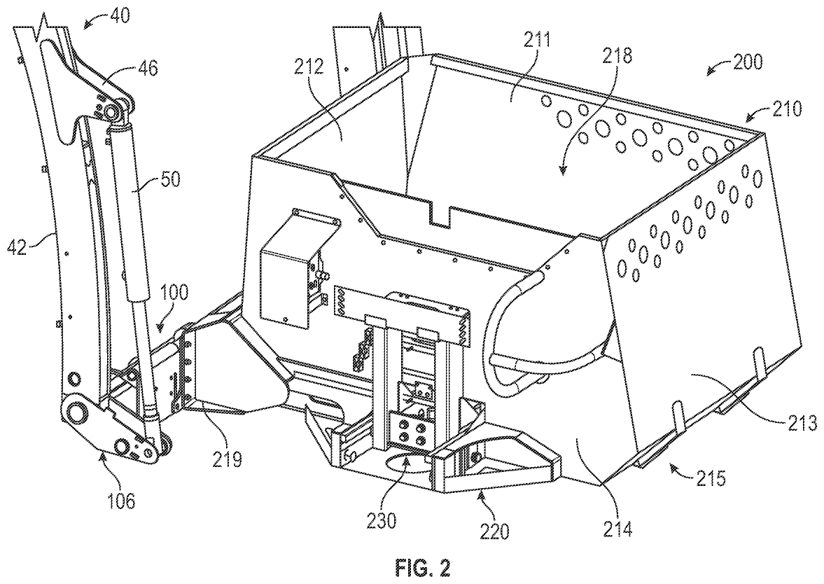

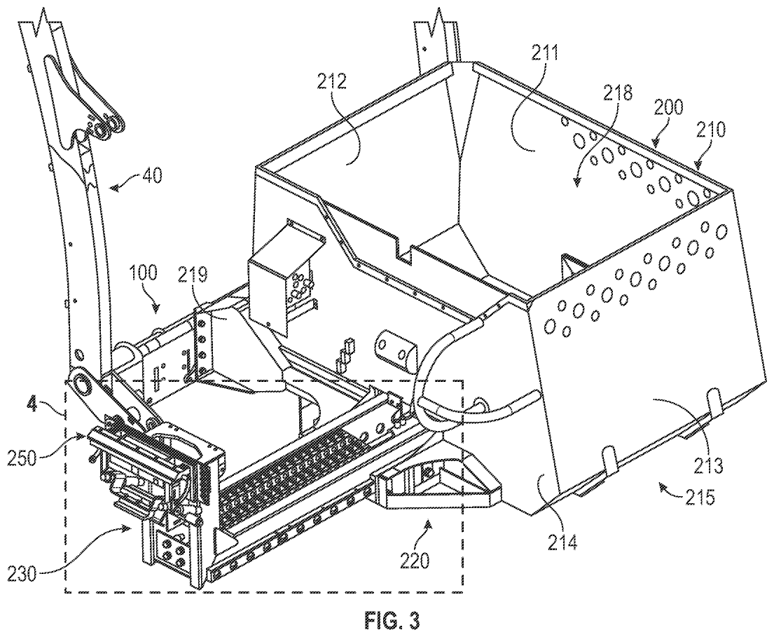

As shown in FIGS. 1 and 2, an attachment assembly, shown as attachment assembly 100, is coupled to the lift arms 42 of the lift assembly 40. As shown in FIGS. 2 and 3, the attachment assembly 100 is configured to engage with interfaces, shown as attachment interfaces 219, of a first accessory (e.g., an accessory, a first attachment, an attachment, a carry can, an intermediate carry can, etc.), shown as container attachment 200, to selectively and releasably secure the container attachment 200 to the lift assembly 40. In other embodiments, the attachment assembly 100 is configured to engage with one or more additional attachments (e.g., fork arms, etc.) to selectively and releasably secure the additional attachments to the lift assembly 40.

As shown in FIG. 1, the lift arms 42 are rotated by the lift arm actuators 44 to lift the container attachment 200 or other attachments over the cab 16. As shown in FIGS. 1 and 2, the lift assembly 40 includes second actuators, shown as articulation actuators 50 (e.g., hydraulic cylinders, etc.), extending between first brackets, shown as lift arm bracket 46, positioned along the lift arms 42 and second brackets, shown as attachment assembly brackets 106, positioned at opposing ends to of the attachment assembly 100. According to an exemplary embodiment, the articulation actuators 50 are positioned to articulate the attachment assembly 100. Such articulation may assist in tipping refuse out of the container attachment 200 and into the hopper volume of the refuse compartment 30 through an opening in the cover 36. The lift arm actuators 44 may thereafter rotate the lift arms 42 to return the empty container attachment 200 to the ground. According to an exemplary embodiment, a door, shown as top door 38 is movably coupled along the cover 36 to seal the opening thereby preventing refuse from escaping the refuse compartment 30 (e.g., due to wind, bumps in the road, etc.).

As shown in FIGS. 2 and 3, the container attachment 200 includes a container, shown as a refuse container 210; a support, shown as arm support 220; and an arm, shown as extension arm 230. The refuse container 210 has a first wall, shown as front wall 213; an opposing second wall, shown as rear wall 212 (e.g., positioned between the cab 16 and the front wall 213, etc.); a first sidewall, shown as left sidewall 211; an opposing second sidewall, shown as right sidewall 214; and a bottom surface, shown as bottom 215. The front wall 213, the rear wall 212, the left sidewall 211, the right sidewall 214, and the bottom 215 cooperatively define an internal cavity, shown as container refuse compartment 218. According to an exemplary embodiment, the container refuse compartment 218 is configured to receive refuse from a refuse container (e.g., a residential garbage can, a recycling bin, etc.).

As shown in FIGS. 2 and 3, the arm support 220 is coupled to the right sidewall 214. In other embodiments the arm support 220 is otherwise positioned (e.g., coupled to the left sidewall 211, the rear wall 212, the front wall 213, the bottom 215, etc.).

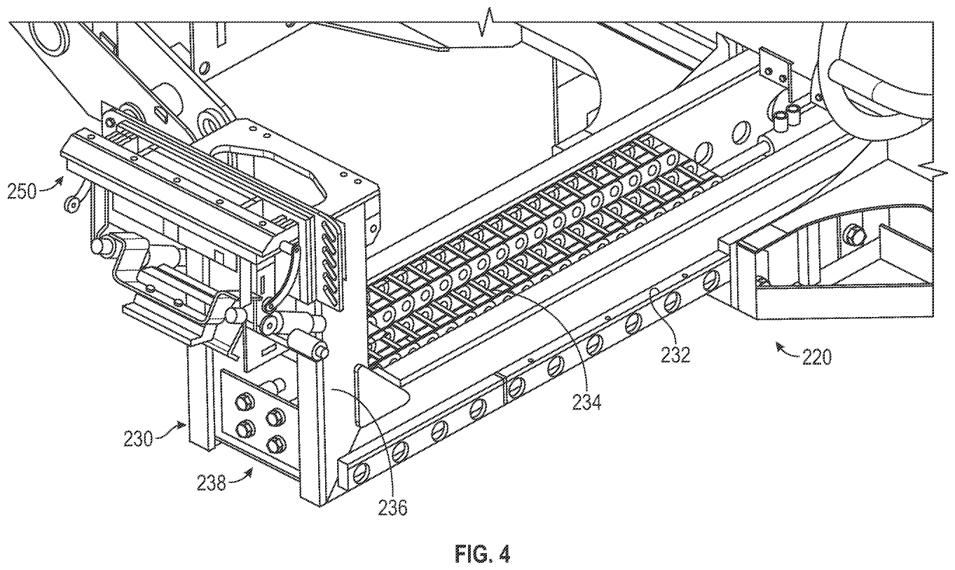

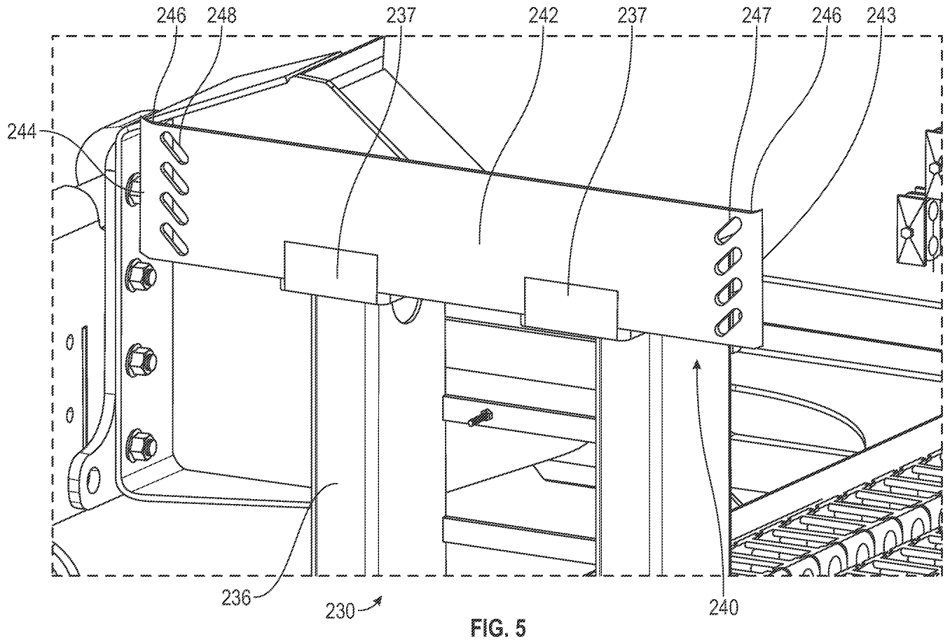

As shown in FIGS. 2-4, the extension arm 230 is coupled to the arm support 220. In other embodiments, the extension arm 230 is otherwise coupled to the container attachment 200 (e.g., coupled to the right sidewall 214, coupled to the left sidewall 211, the rear wall 212, the front wall 213, the bottom 215, etc.). As shown in FIGS. 4 and 5, the extension arm 230 includes a slide, shown as telescoping slide 232, that is slidably received by the arm support 220 and recessed within the refuse container 210; an actuator, shown as extension actuator 234; a frame assembly, shown as attachment frame 236, coupled to a free end, shown as distal end 238, of the telescoping slide 232; an interface, shown as distal interface 237, positioned at an upper end of the attachment frame 236; and a first attachment mechanism, shown as attachment plate 240 (e.g., an attachment member, an attachment bar, an attachment bar, an adapter, etc.), coupled to the distal interface 237 of the attachment frame 236 at the distal end 238 of the extension arm 230. The distal interface 237 may include one or more supports or mounts that receive, engage, support, etc. the attachment plate 240. According to an exemplary embodiment, the extension actuator 234 is configured to extend the telescoping slide 232 from and retract the telescoping slide 232 into the refuse container 210 and the arm support 220. In various embodiments, the extension arm 230 includes a linear actuator, a scissor arm, a rack and pinion, a push chain, and/or still another type of actuator that facilitates extending and retracting the extension arm 230. According to the exemplary embodiment shown in FIGS. 2-5, the extension arm 230 is configured to extend laterally in a direction transverse to the direction of travel of the refuse vehicle 10. In other embodiments, the extension arm 230 extends in alternate directions (e.g., with the direction of travel, against the direction of travel, angled relative to the direction of travel, etc.).

According to an exemplary embodiment, the telescoping slide 232, the attachment frame 236, and the attachment plate 240 of the extension arm 230 are integrally formed (e.g., form a single weldment). In other embodiments, one or more components the extension arm 230 are otherwise coupled together (e.g., fastened, adhesively coupled, etc.). By way of example, the attachment plate 240 may be releasably coupled to the distal interface 237 of the attachment frame 236.

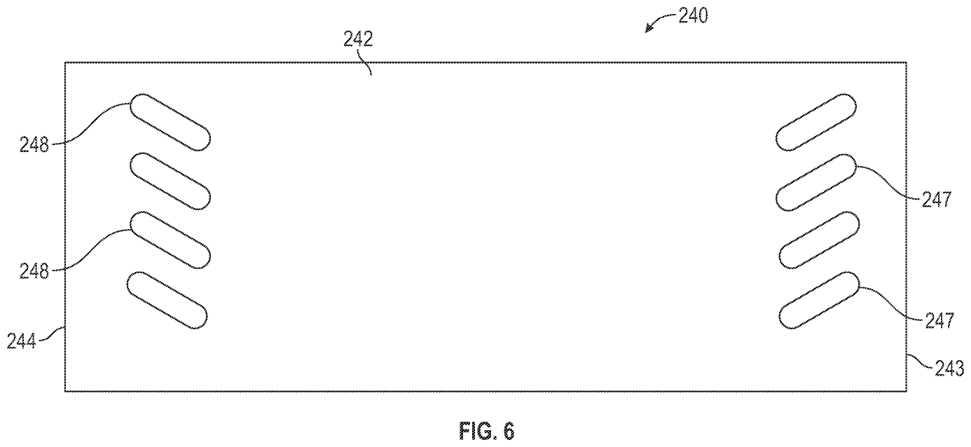

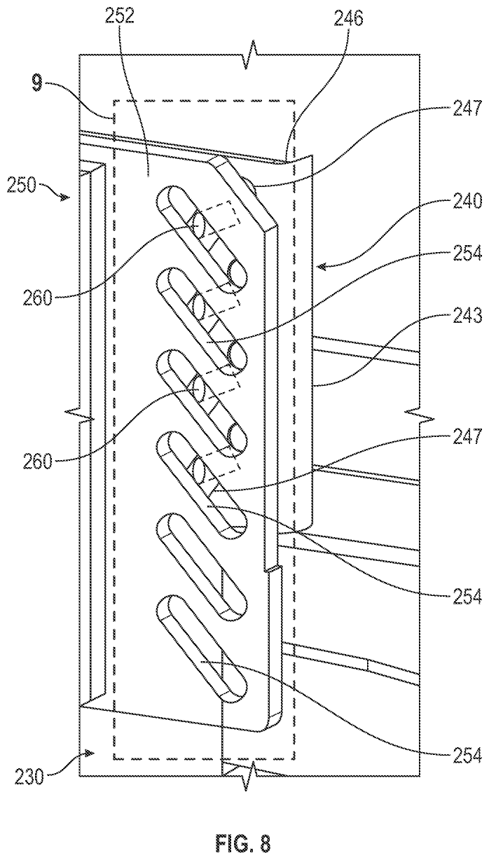

As shown in FIGS. 5 and 6, the attachment plate 240 has a first edge, shown as forward edge 243, and an opposing second edge, shown as rearward edge 244. The attachment plate defines an interface (e.g., a slot/bolt pattern), shown as attachment interface 242, between the forward edge 243 and the rearward edge 244. As shown in FIGS. 5 and 8, the attachment plate 240 has a pair of bends, shown as bends 246, positioned at the forward edge 243 and the rearward edge 244, and that extend from the attachment plate 240 towards the refuse container 210. In some embodiments, the attachment plate 240 does not include the bends 246 such that the attachment plate 240 is substantially flat. In still other embodiments, the bends 246 extend in alternate directions (e.g., away from the refuse container 210, upwards, downwards, etc.).

As shown in FIGS. 5-8, the attachment interface 242 of the attachment plate 240 defines (a) a first plurality of apertures (e.g., holes, slots, etc.), shown as first apertures 247, positioned proximate the forward edge 243 of the attachment plate 240 and spaced vertically along at least a portion of the height of the attachment plate 240 and (b) a second plurality of apertures, shown as second apertures 248, positioned proximate the rearward edge 244 of the attachment plate 240 and spaced vertically along at least a portion of the height of the attachment plate 240. In other embodiments, the first apertures 247 and the second apertures 248 are positioned alternatively (e.g., (a) the first apertures 247 are positioned proximate a top edge of the attachment plate 240 and spaced horizontally along at least a portion of the width of the attachment plate 240 and (b) the second apertures 248 are positioned proximate a bottom edge of the attachment plate 240 and spaced horizontally along at least a portion of the width of the attachment plate 240, etc.).

According to the exemplary embodiment shown in FIGS. 5 and 6, each of the first apertures 247 and each of the second apertures 248 are configured as first slots oriented at a first angle (e.g., 45 degrees, 30 degrees, 60 degrees, etc.) with the outermost ends thereof positioned higher than the innermost ends thereof. In some embodiments, the first slots are oriented such that the outermost ends thereof are lower than the innermost ends thereof. In some embodiments, the first slots are oriented horizontally. In some embodiments, the first slots are orientated vertically. In other embodiments, each the first apertures 247 and each the second apertures 248 are configured as a plurality of circular holes. In still other embodiments, each of the first apertures 247 is configured as a circular hole and each of the second apertures 248 is configured as a slot (e.g., angled, horizontal, etc.). Accordingly, the first apertures 247 and the second apertures 248 may be the same or different.

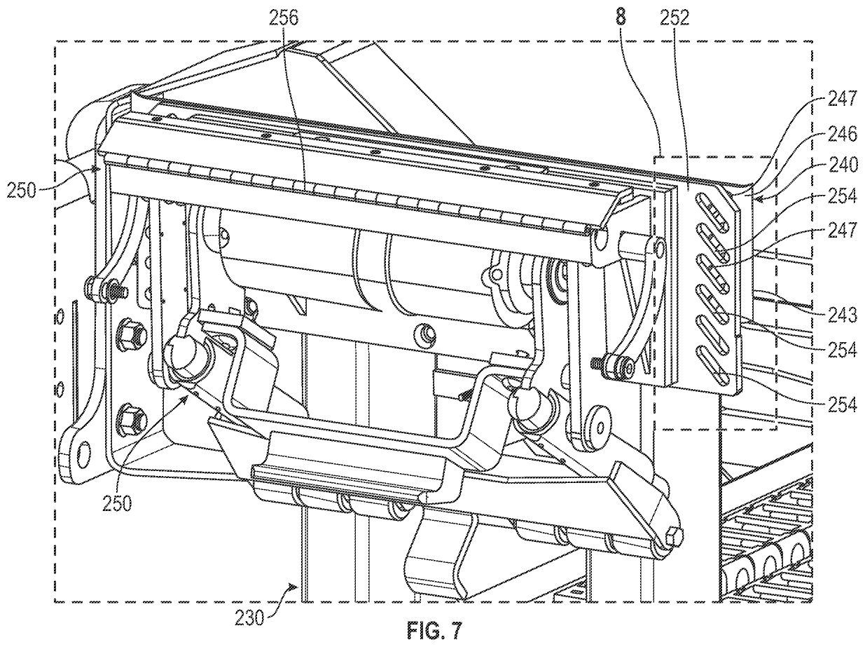

As shown in FIGS. 3, 4, 7, and 8, a first attachment, attachment device, or attachment assembly, shown as tipping device 250 (e.g., a lifting device, a lift assembly, a cart tipper/dumper assembly, etc.), is coupled to the attachment plate 240 of the extension arm 230. As shown in FIGS. 7 and 8, the tipping device 250 includes a second attachment mechanism, shown as first coupling plate 252, and a first manipulator (e.g., refuse container lift device), shown as tipper 256, coupled to the first coupling plate 252.

As shown in FIGS. 7 and 8, the first coupling plate 252 defines a plurality of apertures (e.g., a plurality of coupling apertures, etc.), shown as coupling apertures 254, positioned at least partially along a height of the first coupling plate 252 at opposing ends thereof. According to the exemplary embodiment shown in FIGS. 7 and 8, the coupling apertures 254 are configured as second slots oriented at a second angle (e.g., 45 degrees, 30 degrees, 60 degrees, etc.) with the outermost ends thereof positioned lower than the innermost ends thereof. In some embodiments, the second slots are oriented such that the outermost ends thereof are higher than the innermost ends thereof. In some embodiments, the second slots are oriented horizontally. In some embodiments, the second slots are orientated vertical. As shown in FIGS. 7-9, the second angle of the second slots of the first coupling plate 252 and the first angle of the first slots of the attachment plate 240 are oriented perpendicular or substantially perpendicular to each other. In other embodiments, each the coupling apertures 254 is configured as a circular hole. In still other embodiments, each of the coupling apertures 254 positioned proximate a first end of the first coupling plate 252 is configured as a circular hole and each of the coupling apertures 254 positioned proximate an opposing second end of the first coupling plate 252 is configured as a slot (e.g., angled, horizontal, etc.). Accordingly, the coupling apertures 254 at the opposing ends of the first coupling plate 252 may be the same or different.

As shown in FIGS. 7 and 8, the attachment plate 240 is configured to selectively interface with the first coupling plate 252 to facilitate detachably coupling the tipping device 250 to the extension arm 230. Specifically, the first apertures 247 and the second apertures 248 of the attachment interface 242 of the attachment plate 240 are configured to align with the coupling apertures 254 of the first coupling plate 252. As shown in FIG. 8, the first apertures 247 and the second apertures 248 of the attachment interface 242 and the coupling apertures 254 of the first coupling plate 252 align to selectively receive a plurality of fasteners (e.g., bolts, pins, etc.), shown as mounting fasteners 260, to selectively couple (e.g., mount, secure, attach, etc.) the attachment plate 240 to the first coupling plate 252, thereby, the tipping device 250 to the extension arm 230. According to an exemplary embodiment, the center of the first slots and the second slots are centered and align, however, the first slots and the second slots facilitate sliding or manipulating the alignment of the first coupling plate 252 relative to the attachment plate 240 to accommodate manufacturing tolerances during installation of the tipping device 250 to the extension arm 230.

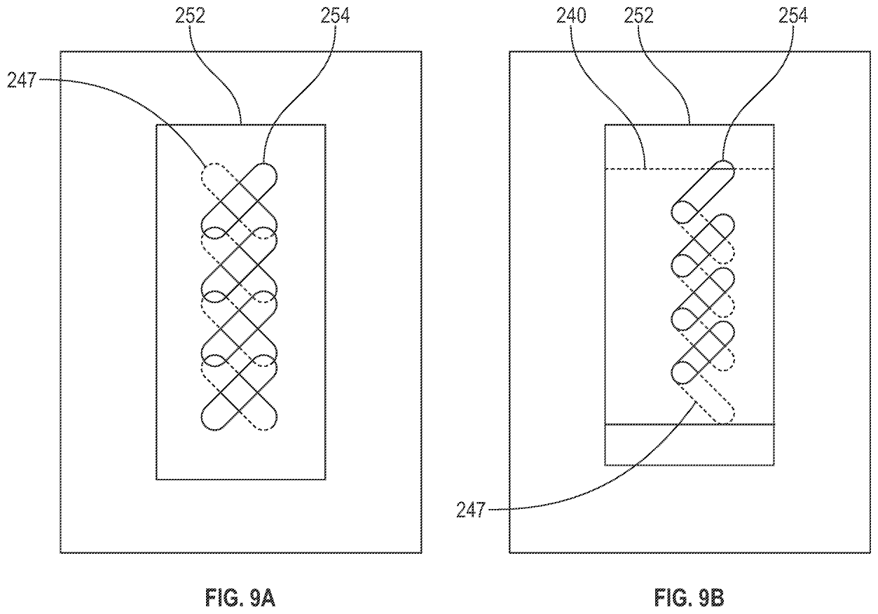

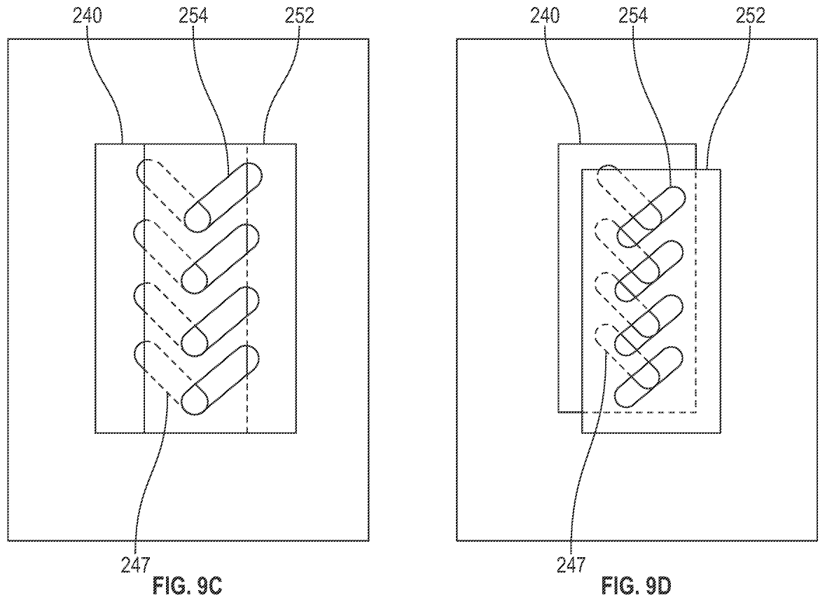

As shown in FIGS. 9A and 9B, the coupling apertures 254 of the first coupling plate 252 and the first apertures 247 and the second apertures 248 of the attachment interface 242 facilitate vertically adjusting the position of the first coupling plate 252 along the attachment plate 240. Accordingly, the vertical position of the tipping device 250 may be adjusted as needed for desired operation.

As shown in FIGS. 9A and 9C, the coupling apertures 254 of the first coupling plate 252 and the first apertures 247 and the second apertures 248 of the attachment interface 242 facilitate horizontally adjusting the position of the first coupling plate 252 along the attachment plate 240. Accordingly, the horizontal position of the tipping device 250 may be adjusted as needed for desired operation.

As shown in FIGS. 9A and 9D, the coupling apertures 254 of the first coupling plate 252 and the first apertures 247 and the second apertures 248 of the attachment interface 242 facilitate both horizontally adjusting and vertically adjusting the position of the first coupling plate 252 along the attachment plate 240. Accordingly, the horizontal position and the vertical position of the tipping device 250 may be both adjusted as needed for desired operation. In various embodiments, the coupling apertures 254 of the first coupling plate 252 and the first apertures 247 and the second apertures 248 of the attachment interface 242 facilitate rotational adjusting (e.g., pivoting, etc.) the position of the first coupling plate 252 relative to the attachment plate 240.

In some embodiments, the mounting fasteners 260 are configured to selectively limit the adjustment of the position of the first coupling plate 252 along the attachment plate 240. The mounting fasteners 260 may be configured to apply a clamping force to the attachment plate 240 and to the first coupling plate 252 to selectively limit the adjustment of the position of the first coupling plate 252 along the attachment plate 240. For example, the mounting fasteners 260 may include a bolt and a nut, where the bolt extends through (i) one of the first apertures 247 or one of the second apertures 248 of the attachment interface 242 of the attachment plate 240 and (ii) one of the coupling apertures 254 of the first coupling plate 252. The nut may be threaded onto the bolt and tightened against the attachment plate 240 or the first coupling plate 252 to elongate (e.g., stretch, etc.) the bolt (e.g., which may contact the attachment plate 240 or the first coupling plate 252, etc.). The elongation of the bolt produces a spring force that may be applied by the bold and/or the nut to produce a clamp load that reduces (e.g., eliminates, etc.) movement between the attachment plate 240 and the first coupling plate 252 due to friction between the attachment plate 240 and the first coupling plate 252 and the clamp load. In other embodiments, the mounting fasteners 260 are alternatively configured to selectively limit the adjustment of the position of the first coupling plate 252 along the attachment plate 240 (e.g., the mounting fasteners 260 are configured to engage the attachment plate 240 and engage the first coupling plate 252 to limit the adjustment of the position of the first coupling plate 252, etc.).

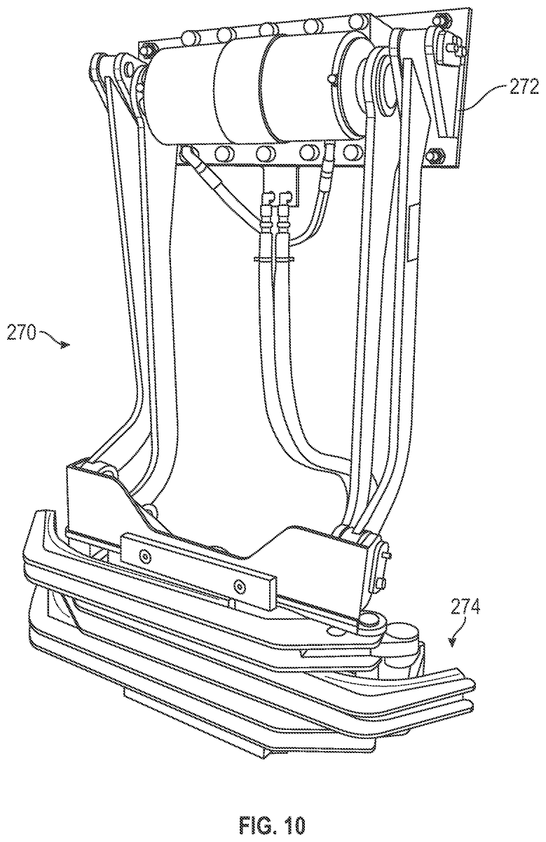

As shown in FIG. 10, a second attachment, attachment device, or attachment assembly, shown as grabber device 270 (e.g., a lifting device, a lift assembly, a cart tipper/dumper assembly, etc.), includes a third attachment mechanism, shown as second coupling plate 272, and a second manipulator (e.g., refuse container grabbing and/or lift device), shown as grabber 274, coupled to the second coupling plate 272. The second coupling plate 272 is configured to selectively interface with the first coupling plate 252 to facilitate detachably coupling the grabber device 270 to the extension arm 230. Specifically, the second coupling plate 272 may define a plurality of apertures configured to align with the first apertures 247 and the second apertures 248 of the attachment interface 242 of the attachment plate 240. The apertures of the second coupling plate 272 and the first apertures 247 and the second apertures 248 of the attachment interface 242 may selectively align to receive the mounting fasteners 260 to selectively couple the attachment plate 240 to the second coupling plate 272, thereby, the grabber device 270 to the extension arm 230. According to an exemplary embodiment, the first slots facilitate sliding or manipulating the alignment of the second coupling plate 272 relative to the attachment plate 240 to accommodate manufacturing tolerances during installation of the grabber device 270 to the extension arm 230.

According to an exemplary embodiment, the second coupling plate 272 is substantially similar to or the same as the first coupling plate 252 such that the second coupling plate 272 is configured to interface with the attachment plate 240 to detachably couple the grabber device 270 to the extension arm 230. Accordingly, the grabber device 270 is selectively interchangeable with the tipping device 250. In other embodiments, the second coupling plate 272 is configured to interface with the attachment plate 240 to detachably couple the grabber device 270 to the extension arm 230 without being substantially similar or the same as the first coupling plate 252. Accordingly, the grabber device 270 is selectively interchangeable with the tipping device 250 even when the second coupling plate 272 is not substantially similar or the same as the first coupling plate 252.

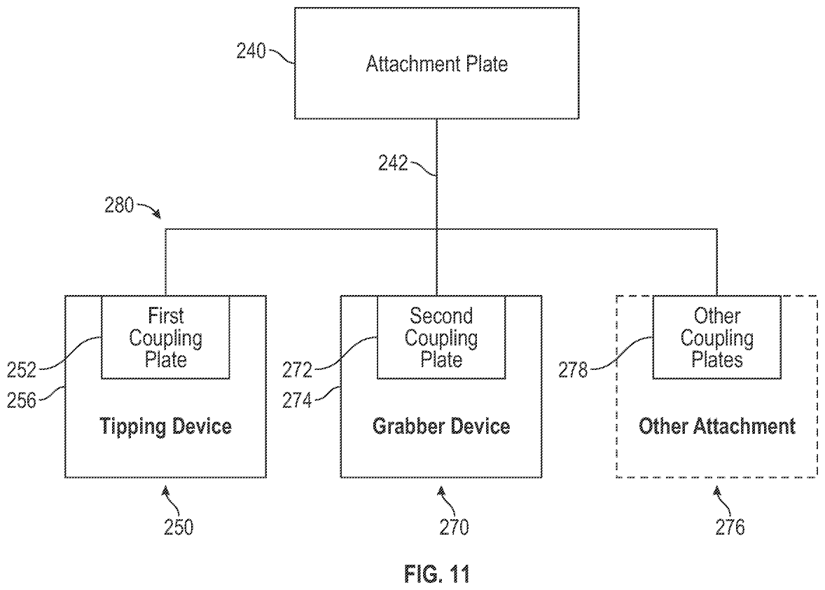

As shown in FIG. 11, a plurality of manipulator assemblies, shown as attachments 280, including the tipping device 250, the grabber device 270, and/or one or more other manipulator assemblies, shown as other attachments 276 (e.g., an elevator, a conveyor, etc.). As shown in FIG. 11, the other attachments 276 include coupling plates, shown as other coupling plates 278. In some embodiments, the other coupling plates 278 may be substantially similar to or the same as the first coupling plate 252 and the second coupling plate 272 such that the other coupling plates 278 are configured to interface with the attachment plate 240 to detachably couple the other attachments 276 to the extension arm 230. Accordingly, the other attachments 276 are selectively interchangeable with the tipping device 250 or the grabber device 270. In other embodiments, the other coupling plates may be configured to interface with the attachment plate 240 to detachably couple the other attachments 276 to the extension arm 230 without being substantially similar to or the same as the first coupling plate 252 or the second coupling plate 272. Accordingly, the other attachments 276 are selectively interchangeable with the tipping device 250 and the grabber device 270 even when the other coupling plates 278 are not substantially similar or the same as the first coupling plate 252 or the second coupling plate 272.

As shown in FIG. 11, the attachment interface 242 of the attachment plate 240 is configured to releasably receive and interface with (a) the first coupling plate 252 to facilitate coupling with the tipping device 250, (b) the second coupling plate 272 to facilitate coupling with the grabber device 270, and (c) the other coupling plates 278 to facilitate coupling with the other attachments 276. Additionally, the attachment interface 242 is configured to allow for an adjustment of a position of the first coupling plate 252, the second coupling plate 272, and the other coupling plates 278 relative to the attachment plate 240 when the first coupling plate 252, the second coupling plate 272, or the other coupling plates 278 are coupled to the attachment interface 242, respectively. In this manner, the attachment plate 240 is configured to releasably receive and adjustably interface with each of the attachments 280 at discrete moments in time.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled”, and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10, the attachment assembly 100, the container attachment 200, the extension arm 230, the attachment plate 240, and components thereof as shown in the various exemplary embodiments is illustrative only. Additionally, any element disclosed in one embodiment may be incorporated or utilized with any other embodiment disclosed herein.

1. An intermediate carry can for a refuse vehicle, the intermediate carry can comprising:
a container configured to couple to the refuse vehicle;
an extension arm coupled to the container; and
an attachment member coupled to an end of the extension arm, the attachment member having an interface configured to engage with a plurality of attachments to facilitate selectively interchanging the plurality of attachments, the interface defining a first plurality of apertures and a second plurality of apertures that facilitate adjusting a position of at least one of the plurality of attachments relative to the attachment member.

2. The intermediate carry can of claim 1, wherein the first plurality of apertures and the second plurality of apertures are spaced vertically along at least a portion of a height of the attachment member.

3. The intermediate carry can of claim 2, wherein the first plurality of apertures and the second plurality of apertures are configured as first slots orientated at a first angle.

4. The intermediate carry can of claim 3, wherein the first plurality of apertures and the second plurality of apertures facilitate adjusting the position of the at least one of the plurality of attachments horizontally along the attachment member and vertically along the attachment member.

5. The intermediate carry can of claim 4, wherein the attachment member further has a first edge and an opposing second edge; and
wherein the first plurality of apertures are positioned proximate the first edge and the second plurality of apertures are positioned proximate the opposing second edge.

6. The intermediate carry can of claim 5, wherein an outermost end of the first plurality of apertures proximate the first edge is positioned higher than an innermost end of the first plurality of apertures; and
wherein an outermost end of the second plurality of apertures proximate the opposing second edge is positioned higher than an innermost end of the second plurality of apertures.

7. The intermediate carry can of claim 5, wherein the attachment member includes a pair of bends positioned at the first edge and the opposing second edge and extending from the attachment member towards the container.

8. The intermediate carry can of claim 1 further comprising:
a plurality of fasteners extending through one of the first plurality of apertures of the second plurality of apertures configured to engage the attachment member with the plurality of attachments, wherein the plurality of fasteners are configured to selectively limit adjusting the position of the at least one of the plurality of attachments relative to the attachment member.

9. The intermediate carry can of claim 8, wherein the plurality of fasteners are configured to selectively apply a clamp load on the attachment member and the at least one of the plurality of attachments to selectively limit adjusting the position of the at least one of the plurality of attachments relative to the attachment member.

10. The intermediate carry can of claim 9, wherein each of the plurality of fasteners comprise:
a bolt extending through (i) one of the first plurality of apertures or the second plurality of apertures of the interface of the attachment member and (ii) the at least one of the plurality of attachments; and
a nut threaded onto the bolt and tightened against the attachment member or the at least one of the plurality of attachments to selectively apply the clamp load on the attachment member and the at least one of the plurality of attachments.

11. The intermediate carry can of claim 1, wherein the plurality of attachments comprise:
a first attachment comprising a first manipulator configured to engage a first type of a refuse container; and
a second attachment comprising a second manipulator configured to engage a second type of refuse container.

12. The intermediate carry can of claim 11, wherein the first plurality of apertures and the second plurality of apertures facilitate adjusting the position of the first attachment and the second attachment relative to the attachment member.

13. The intermediate carry can of claim 12 further comprising:
a plurality of fasteners extending through one of the first plurality of apertures of the second plurality of apertures configured to engage the attachment member with the plurality of attachments, wherein the plurality of fasteners are configured to selectively limit adjusting the position of the first attachment and the second attachment relative to the attachment member.

14. The intermediate carry can of claim 1, wherein the first plurality of apertures and the second plurality of apertures facilitate adjusting the position of the plurality of attachments relative to the attachment member.

15. The intermediate carry can of claim 14 further comprising:
a plurality of fasteners extending through one of the first plurality of apertures of the second plurality of apertures configured to engage the attachment member with the plurality of attachments, wherein the plurality of fasteners are configured to selectively limit adjusting the position of the plurality of attachments relative to the attachment member.

16. The intermediate carry can of claim 1, wherein:
each of the plurality of attachments include a coupling plate defining a plurality of coupling apertures, the plurality of coupling apertures configured to selectively align with the first plurality of apertures and the second plurality of apertures; and
the intermediate carry can further comprises a plurality of fasteners configured to extend through (i) the first plurality of apertures or the second plurality of apertures of the interface of the attachment member and (ii) the plurality of coupling apertures of the coupling plates of the plurality of attachments for the interface to engage the plurality of attachments.

17. The intermediate carry can of claim 16, wherein the plurality of fasteners are configured to selectively limit adjusting the position of each of the plurality of attachments relative to the attachment member when the plurality of fasteners extend through (i) the first plurality of apertures or the second plurality of apertures of the interface of the attachment member and (ii) the plurality of coupling apertures of the coupling plates of the plurality of attachments.

18. The intermediate carry can of claim 17, wherein an outermost end of each of the first plurality of apertures and each of the second plurality of apertures is higher than an innermost end of each of the first plurality of apertures and each of the second plurality of apertures; and
wherein an outermost end of each of the plurality of coupling apertures of the coupling plate of at least one of the plurality of attachments is lower than an innermost end of each of the plurality of coupling apertures of the coupling plate of the at least one of the plurality of attachments.

19. An intermediate carry can for a refuse vehicle, the intermediate carry can comprising:
a container configured to couple to the refuse vehicle;
an extension arm coupled to the container, the extension arm configured to extend laterally in a direction transverse to a direction of travel of the refuse vehicle; and
an attachment member coupled to an end of the extension arm, the attachment member having an interface configured to engage with a plurality of attachments to facilitate selectively interchanging the plurality of attachments including a first manipulator configured to engage a first type of refuse container and a second manipulator configured to engage a second type of refuse container.

20. A refuse vehicle comprising:
a chassis;
a body assembly coupled to the chassis, the body assembly defining a vehicle refuse compartment;
a lift assembly;
an attachment assembly coupled to the lift assembly; and
an accessory selectively secured to the lift assembly by the attachment assembly, the accessory comprising:
an extension arm configured to extend laterally in a direction transverse to a direction of travel of the refuse vehicle, and
an attachment member coupled to an end of the extension arm, the attachment member having an interface configured to engage with a plurality of attachments to facilitate selectively interchanging the plurality of attachments, the interface defining a first plurality of apertures and a second plurality of apertures that facilitate adjusting a position of at least one of the plurality of attachments relative to the attachment member.
